(19) United States
(12) Patent Application Publication
(10) Pub. No.: US 2014/0170421 A1
(43) Pub. Date: Jun. 19, 2014

(54) Low-E Panel with Improved Barrier Layer and Method for Forming the Same

(71) Applicant: INTERMOLECULAR INC., San Jose, CA (US)

(72) Inventors: Guowen Ding, San Jose, CA (US); Brent Boyce, Novi, MI (US); Minh Huu Le, San Jose, CA (US); Zhi-Wen Wen Sun, Sunnyvale, CA (US); Yu Wang, San Jose, CA (US); Yongli Xu, Plymouth, MI (US)

(73) Assignee: INTERMOLECULAR INC., San Jose, CA (US)

(21) Appl. No.: 13/715,396

(22) Filed: Dec. 14, 2012

(51) Int. Cl. B05D 5/06

(52) U.S. Cl. CPC B05D 5/063
USPC 428/432; 427/164; 428/701; 428/472

(57) ABSTRACT

Embodiments provided herein describe low-e panels and methods for forming low-e panels. A transparent substrate is provided. A reflective layer is formed above the transparent substrate. A titanium-yttrium oxide layer is deposited above the transparent substrate, or above the transparent substrate and the reflective layer, which may enhance optical performance.

The present invention relates to low-e panels. More particularly, this invention relates to low-e panels having an improved barrier layer and methods for forming such low-e panels.

### BACKGROUND OF THE INVENTION

Low emissivity, or low-e, panels are often formed by depositing a reflective layer (e.g., silver), along with various other layers, onto a transparent (e.g., glass) substrate. The various layers typically include various dielectric and metal oxide layers, such as silicon nitride, tin oxide, and zinc oxide, to provide a barrier between the stack and both the substrate and the environment, as well as to act as optical fillers and function as anti-reflective coating layers to improve the optical characteristics of the panel.

In recent years, the use of titanium in the “barrier layer,” often formed directly above the reflective layer, has been shown to provide desirable optical performance. However, in order to achieve this performance, the process steps used to form the titanium barrier layer must be performed very precisely. For example, while a precisely formed titanium barrier may demonstrate excellent optical performance, minor variations in the thickness of such a barrier layer may result in poor optical performance.

### BRIEF DESCRIPTION OF THE DRAWINGS

To facilitate understanding, identical reference numerals have been used, where possible, to designate identical elements that are common to the figures. The drawings are not to scale and the relative dimensions of various elements in the drawings are depicted schematically and not necessarily to scale.

The techniques of the present invention can readily be understood by considering the following detailed description in conjunction with the accompanying drawings, in which:

FIG. 1 is a cross-sectional side view of a low-e panel according to some embodiments of the present invention.

FIG. 2 is a graph illustrating the thickness of various barrier layers, according to various embodiments of the present invention, and the respective refractive indices thereof.

FIG. 3 is a simplified cross-sectional diagram illustrating a physical vapor deposition (PVD) tool according to some embodiments of the present invention.

### DETAILED DESCRIPTION

A detailed description of one or more embodiments is provided below along with accompanying figures. The detailed description is provided in connection with such embodiments, but is not limited to any particular example. The scope is limited only by the claims and numerous alternatives, modifications, and equivalents are encompassed. Numerous specific details are set forth in the following description in order to provide a thorough understanding. These details are provided for the purpose of example and the described techniques may be practiced according to the claims without some or all of these specific details. For the purpose of clarity, technical material that is known in the technical fields related to the embodiments has not been described in detail to avoid unnecessarily obscuring the description.

Embodiments described herein provide methods for forming low-e panels in such a way to reduce the refractive index of the reflective layer (e.g., silver layer) and provide a wider acceptable process window (e.g., with respect to thickness). This is accomplished by using, for example, a titanium-yttrium oxide in the stack of materials formed on the substrate, such as in a barrier layer adjacent to the reflective layer.

In some embodiments, a transparent substrate is first provided. A reflective layer is formed over the transparent substrate. A barrier layer material is deposited over the transparent substrate. The barrier layer material comprises titanium-yttrium oxide before the barrier layer material is deposited over the transparent substrate. More particularly, the oxide may be formed before the barrier layer material contacts the portions of the low-e panel that are already in place (e.g., the portions of the “stack” below the barrier layer material).

The barrier layer material may form a barrier layer adjacent to the reflective layer. The barrier layer may comprise, for example, substantially equal amounts of titanium and yttrium. However, in other embodiments, the amount of yttrium may be greater than the amount of titanium. The barrier layer may have a thickness of at least 30 Å, such as between 30 and 100 Å.

The use of titanium-yttrium oxide in the barrier layer effectively reduces the refractive index of the reflective layer (e.g., silver) and allows for a greater variation in the thickness of the barrier layer while still maintaining desirable performance. For example, the barrier layer utilizing titanium-yttrium oxide may vary in thickness by as much as 10 Å, while conventional titanium barrier layers may only vary by no more than 2 Å and still provide acceptable performance.

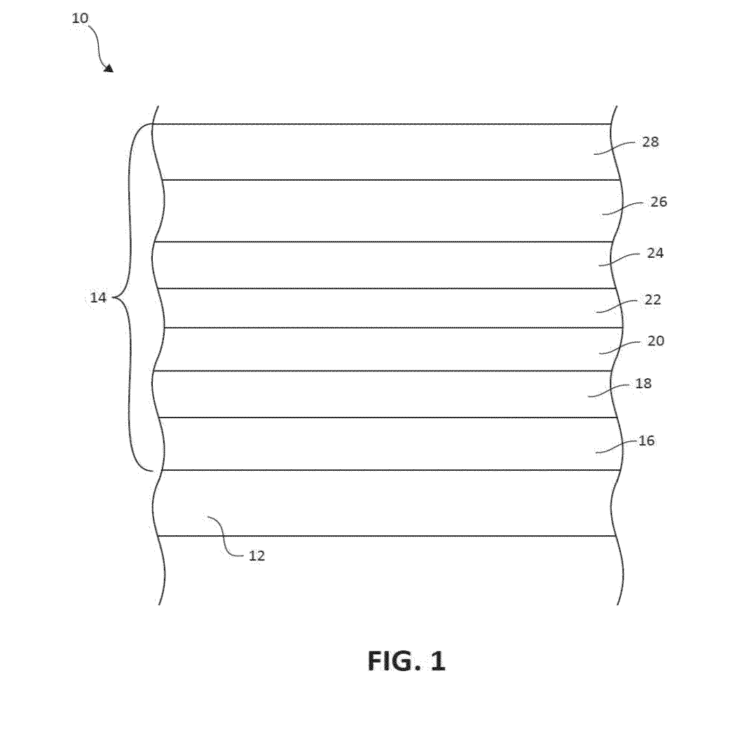

FIG. 1 illustrates a low-e panel 10 according to some embodiments of the present invention. The low-e panel 10 includes a transparent substrate 12 and a low-e stack 14 formed over the substrate 12. The transparent substrate 12 in some embodiments is made of a low emissivity glass, such as borosilicate glass. However, in other embodiments, the transparent substrate 12 may be made of plastic or polycarbonate. The substrate 12 has a thickness of, for example, between about 1 and about 10 millimeters (mm). In a testing environment, the substrate 12 may be round with a diameter of, for example, about 200 or about 300 mm. However, in a manufacturing environment, the substrate 12 may be square or rectangular and significantly larger (e.g., about 0.5-about 6 meters (m) across).

The low-e stack 14 includes a lower dielectric layer 16, a lower metal oxide layer 18, a seed layer 20, a reflective layer 22, a barrier layer 24, an upper metal oxide layer 26, and an upper dielectric layer 28. Exemplary details as to the functionality provided by each of the layers 16-28 are provided below.

The various layers in the low-e stack 14 may be formed sequentially (i.e., from bottom to top) on the transparent substrate 12 using a physical vapor deposition (PVD) and/or reactive sputtering processing tool. In some embodiments, the low-e stack 14 is formed over the entire substrate 12. However, in other embodiments, the low-e stack 14 may only be formed on isolated portions of the substrate 12.

Still referring to FIG. 1, the lower dielectric layer 16 is formed above (or over) the upper surface of the substrate 12. In some embodiments, the lower dielectric layer 16 is made of silicon nitride and has a thickness of, for example, about 250 Angstroms (Å). The lower dielectric layer 16 may protect the other layers in the stack 14 from any elements which may otherwise diffuse from the substrate 12 and may be used to tune the optical properties (e.g., transmission) of the stack 14 and/or the low-e panel 10 as a whole. For example, the thickness and refractive index of the lower dielectric layer 16 may be altered to increase or decrease visible light transmission.

The lower metal oxide layer 18 is formed above the lower dielectric layer 16. The lower metal oxide layer 18 may be made of a metal oxide and have a thickness of, for example, approximately 150 Å. Examples of metal oxides used in the lower metal oxide layer 18 include, but are not limited to, titanium oxide, zinc oxide, tin oxide, and metal alloy oxides, such as zinc-tin oxide. The lower metal oxide layer 18 may be used to further tune the optical properties of the low-e panel 10 as a whole, as well as to enhance silver nucleation.

The seed layer 20 is formed over the lower metal oxide layer 18. The seed layer 20 is made of a metal oxide and may have a thickness of, for example, approximately 100 Å. In some embodiments, the metal oxide used in the seed layer 20 is zinc oxide. The seed layer 20 may be used to enhance the deposition/growth of the reflective layer 22 on the low-e stack (e.g., enhance the crystalline structure and/or texturing of the reflective layer 22) and increase the transmission of the stack 14 for anti-reflection purposes. It should be understood that in other embodiments, the lower metal oxide layer 18 may be made of tin oxide or may not be included at all.

The reflective layer 22 is formed above the lower metal oxide layer 18. In some embodiments, the reflective layer 22 is made of silver and has a thickness of, for example, about 100 Å. As in commonly understood, the reflective layer 22 is used to reflect infra-red electro-magnetic radiation, thus reducing the amount of heat that may be transferred through the low-e panel 10.

The barrier layer 24 is formed over the reflective layer 22. In accordance with one aspect of the present invention, the barrier layer 24, in at least some embodiments, is made of titanium-yttrium oxide. In some embodiments, the ratio of titanium to yttrium in the barrier layer is approximately 1:1 (i.e., the barrier layer material comprises approximately the same amount of titanium and yttrium). In other embodiments, the barrier layer material comprises more yttrium than titanium (e.g., 51% to 99% yttrium and 1% to 49% titanium). However, in other embodiments, the barrier layer is made of pure yttrium oxide. In some embodiments, the barrier layer 24 may have a thickness that is at least 30 Å and not more than 100 Å. The barrier layer 24 is used to protect the reflective layer 22 from the processing steps used to form the other, subsequent layers of the low-e stack 14 and to prevent any interaction of the material of the reflective layer 22 with the materials of the other layers of the low-e stack 14, which may result in undesirable optical characteristics of the low-e panel 10.

It should be noted that in at least some embodiments, the barrier layer 24 is deposited over the substrate 12 (e.g., adjacent to the reflective layer 22) as an oxide. That is, the oxide is formed prior to the barrier layer material making contact with the substrate 12 and/or the reflective layer 22, as opposed to the oxide being formed by the barrier layer material interacting with another material after being deposited.

Still referring to FIG. 1, the upper metal oxide layer 26 is formed over (e.g., and adjacent to) the barrier layer 24 and may be made with the same material(s) as the lower metal oxide layer 18 (and does not include the same material as the barrier layer 24). Also like the lower metal oxide layer 18, the upper metal oxide layer may be used to further tune the optical properties of the low-e panel 10 as a whole.

The upper dielectric (or protective) layer 28 is formed above the upper dielectric layer 26. In some embodiments, the upper dielectric layer 28, like the lower dielectric layer 16 is made of silicon nitride and has a thickness of, for example, about 250 Å. The protective layer 28 may be used to provide additional protection for the lower layers of the stack 14 and further adjust the optical properties of the stack 14. However, it should be understood that some embodiments may not include the protective layer 28.

It should be noted that depending on the exact materials used, some of the layers of the low-e stack 14 may have some materials in common. An example of such a stack may use a zinc-based material in the lower metal oxide layer 18 and the upper metal oxide layer 26, as well as the seed layer 20. As a result, embodiments described herein may allow for a relatively low number of different targets to be used for the formation of the low-e stack 14.

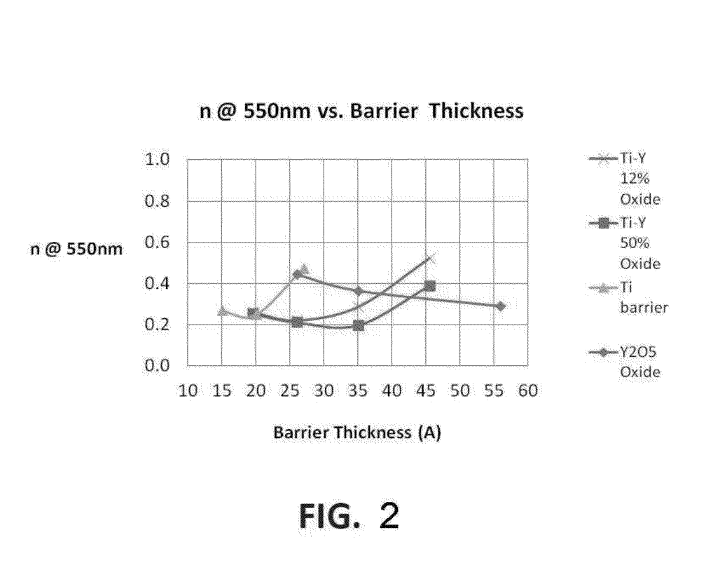

FIG. 2 graphically illustrates the refractive index (i.e., for light with a wavelength of 550 nanometers (nm)) of several barrier layers, at various thicknesses, according to various embodiments of the present invention. As shown, a conventional titanium barrier layer demonstrates a relatively dramatic increase in refractive index at the thickness of the layer is increased over approximately 20 Å (e.g., an increase of refractive index from approximately 0.25 at 20 Å to approximately 0.45 at approximately 27 Å).

In contrast, the change in refractive index demonstrated by the barrier layers described herein is significantly more gradual. For example, a barrier layer that is made of titanium-yttrium oxide, with 88% titanium and 12% yttrium, demonstrates a refractive index of just over 0.2 at 26 Å, 0.3 at 35 Å, and 0.5 at 45 Å. A barrier layer that is made of titanium-yttrium oxide, with 50% titanium and 50% yttrium, demonstrates a refractive index of approximately 0.3 at 20 Å, just over 0.2 at 26 Å, 0.3 at 35 Å, and 0.4 at 45 Å. A barrier layer that is made of yttrium oxide demonstrates a refractive index of approximately 0.45 at 26 Å, 0.37 at 35 Å, and 0.3 at 56 Å. Thus, in the thickness range provided in FIG. 2, the refractive index of a yttrium oxide barrier layer actually decreases as the thickness of the layer increases.

As such, the use of the barrier layer materials described herein allows for a greater range of thicknesses to be used for the barrier layer, thus facilitating processing, as a larger processing window may used while still providing acceptable performance. That is, the overall performance of the panel 10 may be improved as a wider range of barrier layer thickness may be utilized. As a result, manufacturing costs may be reduced.

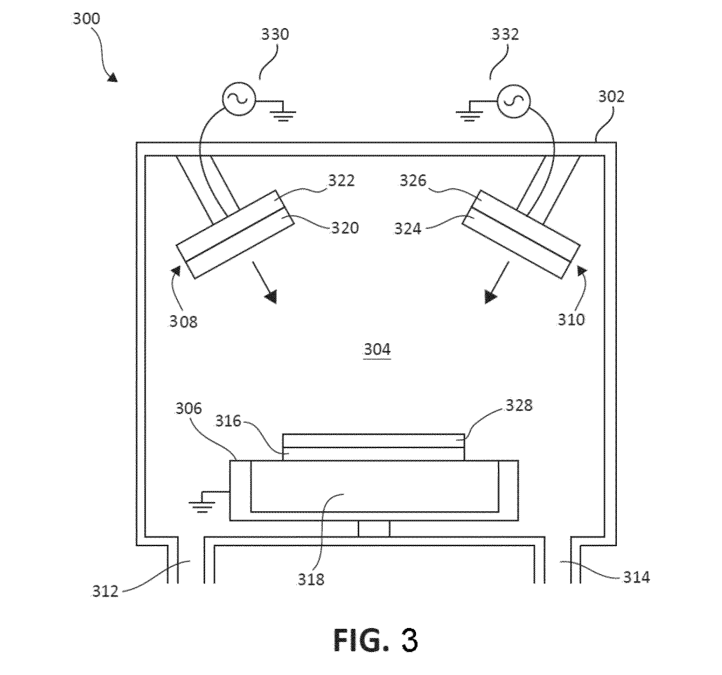

FIG. 3 provides a simplified illustration of a physical vapor deposition (PVD) tool (and/or system) 300 which may be used to formed the low-e panel 10 and/or the low-e stack 14 described above, in accordance with some embodiments of the invention. The PVD tool 300 shown in FIG. 3 includes a housing 302 that defines, or encloses, a processing chamber 304, a substrate support 306, a first target assembly 308, and a second target assembly 310.

The housing 302 includes a gas inlet 312 and a gas outlet 314 near a lower region thereof on opposing sides of the substrate support 306. The substrate support 306 is positioned near the lower region of the housing 302 and in configured to support a substrate 316. The substrate 316 may be a round glass (e.g., borosilicate glass) substrate having a diameter of, for example, about 200 mm or about 300 mm. In other embodiments (such as in a manufacturing environment), the substrate 316 may have other shapes, such as square or rectangular, and may be significantly larger (e.g., about 0.5-about 6 m across). The substrate support 306 includes a support electrode 318 and is held at ground potential during processing, as indicated.

The first and second target assemblies (or process heads) 308 and 310 are suspended from an upper region of the housing 302 within the processing chamber 304. The first target assembly 308 includes a first target 320 and a first target electrode 322, and the second target assembly 310 includes a second target 324 and a second target electrode 326. As shown, the first target 320 and the second target 324 are oriented or directed towards the substrate 316. As is commonly understood, the first target 320 and the second target 324 include one or more materials that are to be used to deposit a layer of material 328 on the upper surface of the substrate 316.

The materials used in the targets 320 and 324 may, for example, include tin, zinc, magnesium, aluminum, lanthanum, yttrium, titanium, antimony, strontium, bismuth, silicon, silver, nickel, chromium, or any combination thereof (i.e., a single target may be made of an alloy of several metals). Additionally, the materials used in the targets may include oxygen, nitrogen, or a combination of oxygen and nitrogen in order to form the oxides, nitrides, and oxynitrides described above. Additionally, although only two targets 320 and 324 are shown, additional targets may be used. As such, different combinations of targets may be used to form, for example, the dielectric layers described above. For example, in embodiments in which the barrier layer 34 is made of titanium-yttrium oxide, the titanium and the yttrium may be provided by separate titanium and yttrium targets, or they may be provided by a single titanium-yttrium alloy target.

The PVD tool 300 also includes a first power supply 330 coupled to the first target electrode 322 and a second power supply 332 coupled to the second target electrode 324. As is commonly understood, the power supplies 330 and 332 pulse direct current (DC) power to the respective electrodes, causing material to be, at least in some embodiments, simultaneously sputtered (i.e., co-sputtered) from the first and second targets 320 and 324.

During sputtering, inert gases, such as argon or krypton, may be introduced into the processing chamber 304 through the gas inlet 312, while a vacuum is applied to the gas outlet 314. However, in embodiments in which reactive sputtering is used, reactive gases may also be introduced, such as oxygen and/or nitrogen, which interact with particles ejected from the targets (i.e., to form oxides, nitrides, and/or oxynitrides), as may be the case with the formation of the titanium-yttrium oxide and yttrium oxide using in barrier layers in accordance with the embodiments described above.

Although not shown in FIG. 3, the PVD tool 300 may also include a control system having, for example, a processor and a memory, which is in operable communication with the other components shown in FIG. 3 and configured to control the operation thereof in order to perform the methods described herein.

Further, although the PVD tool 300 shown in FIG. 3 includes a stationary substrate support 306, it should be understood that in a manufacturing environment, the substrate 316 may be in motion during the various layers described herein.

Thus, in some embodiments, a method for forming a low-e panel is provided. A transparent substrate is provided. A reflective layer is formed above the transparent substrate. A titanium-yttrium oxide layer is deposited above the transparent substrate and adjacent to the reflective layer.

In other embodiments, a method for forming a low-e panel is provided. A glass substrate is provided. A silver layer is formed above the glass substrate. A titanium-yttrium oxide layer is deposited above and adjacent to the silver layer.

In further embodiments, a low-e panel is provided. The low-e panel includes a transparent substrate. A reflective layer is formed above the transparent substrate. A titanium-yttrium oxide layer is formed above and adjacent to the reflective layer. A metal oxide layer is formed above and adjacent to the titanium-yttrium oxide layer. The metal oxide layer does not comprise titanium-yttrium oxide.

Although the foregoing examples have been described in some detail for purposes of clarity of understanding, the invention is not limited to the details provided. There are many alternative ways of implementing the invention. The disclosed examples are illustrative and not restrictive.

What is claimed:

1. A method for forming a low-e panel comprising:
providing a transparent substrate;
forming a reflective layer above the transparent substrate; and
depositing a titanium-yttrium oxide layer above the transparent substrate and adjacent to the reflective layer.

2. The method of claim 1, wherein the titanium-yttrium oxide layer is formed on the reflective layer.

3. The method of claim 2, wherein the titanium-yttrium oxide layer has a thickness of at least 30 Å and not more than 100 Å.

4. The method of claim 1, wherein the reflective layer comprises silver.

5. The method of claim 1, wherein an amount of titanium within the titanium-yttrium oxide layer is approximately equal to an amount of yttrium within the titanium-yttrium oxide layer.

6. The method of claim 1, wherein an amount of titanium within the titanium-yttrium oxide layer is less than an amount of yttrium within the titanium-yttrium oxide layer.

7. The method of claim 1, further comprising forming a metal oxide layer above the titanium-yttrium oxide layer.

8. The method of claim 7, further comprising forming a dielectric layer above the titanium-yttrium oxide layer.

9. The method of claim 1, wherein the transparent substrate comprises glass.

10. The method of claim 1, wherein the depositing of the titanium-yttrium oxide layer comprises causing titanium particles to be ejected from a first target and causing yttrium particles to be ejected from a second target.

11. A method for forming a low-e panel, the method comprising:
providing a glass substrate;
forming a silver layer above the glass substrate; and
depositing a titanium-yttrium oxide layer above and adjacent to the silver layer.

12. The method of claim 11, further comprising forming a metal oxide layer above the titanium-yttrium oxide layer.

13. The method of claim 11, further comprising forming a dielectric layer above the titanium-yttrium oxide layer.

14. The method of claim 13, wherein an amount of titanium within the titanium-yttrium oxide layer is approximately equal to an amount of yttrium within the titanium-yttrium oxide layer.

15. The method of claim 14, wherein the forming of the titanium-yttrium oxide layer comprises causing titanium-yttrium alloy particles to be ejected from a single target.

16. A low-e panel comprising:
a transparent substrate;
a reflective layer formed above the transparent substrate;
a titanium-yttrium oxide layer formed above and adjacent to the reflective layer;
a metal oxide layer formed above and adjacent to the titanium-yttrium oxide layer, wherein the metal oxide layer does not comprise titanium-yttrium oxide.

17. The low-e panel of claim 16, wherein an amount of titanium within the titanium-yttrium oxide layer is approximately equal to an amount of yttrium within the titanium-yttrium oxide layer.

18. The low-e panel of claim 16, wherein an amount of titanium within the titanium-yttrium oxide layer is less than an amount of yttrium within the barrier layer.

19. The low-e panel of claim 16, wherein the transparent substrate comprises glass.

20. The low-e panel of claim 16, wherein the reflective layer comprises silver.
